(19) United States
(12) Patent Application Publication
(10) Pub. No.: US 2026/0109150 A1
(43) Pub. Date: Apr. 23, 2026

(54) LIQUID EJECTION APPARATUS

(71) Applicant: SEIKO EPSON CORPORATION, TOKYO (JP)

(72) Inventor: Taro TAKEKOSHI, SHIOJIRI-SHI (JP)

(21) Appl. No.: 19/363,952

(22) Filed: Oct. 21, 2025

(30) Foreign Application Priority Data
Oct. 22, 2024 (JP) 2024-185805

(51) Int. Cl. B41J 2/17; B41J 2/165

(52) U.S. Cl. CPC B41J 2/1728; B41J 2/16505; B41J 2002/16594

(57) ABSTRACT

A liquid ejection apparatus includes an ejection unit that ejects an ink, a waste liquid container that contains the ink as a waste liquid, and an attachment unit that attaches the waste liquid container, wherein the attachment unit includes an introduction portion that is insertable into the waste liquid container along an X axis and introduces the ink into the waste liquid container, and a holding portion that holds the introduction portion, and the introduction portion is held by the holding portion movably along a Y-Z plane orthogonal to the X axis.

The present application is based on, and claims priority from JP Application Serial Number 2024-185805, filed Oct. 22, 2024, the disclosure of which is hereby incorporated by reference herein in its entirety.

### BACKGROUND

### 1. Technical Field

The present disclosure relates to a liquid ejection apparatus.

### 2. Related Art

JP-A-2020-196271 discloses a waste liquid container that is detachably attached into an attachment chamber of a liquid injection apparatus including a drain unit that drains a liquid drained as a waste liquid from a liquid injection head and an attachment chamber in which the drain unit is provided. A wall portion of the waste liquid container is provided with a waste liquid introduction portion that can introduce the waste liquid into the waste liquid container by being coupled to the drain unit along with the movement of the waste liquid container in a coupling direction. The positions of a seal member forming the waste liquid introduction portion and the drain unit are defined by a guide portion provided in the waste liquid container being guided by a guide protrusion provided in the attachment chamber.

JP-A-2020-196271 is an example of the related art.

However, in the coupling structure by the seal member and the drain unit of JP-A-2020-196271, the positions of the seal member and the drain unit may be shifted due to dimensional variations between the guide portion and the seal member and dimensional variations between the guide protrusion and the drain unit. In this case, there is a concern that the waste liquid leaks in the coupling portion between the seal member forming the waste liquid introduction portion of the waste liquid container and the drain unit.

### SUMMARY

A liquid ejection apparatus according to an aspect of the present disclosure includes an ejection unit that ejects a liquid, a waste liquid container that contains the liquid as a waste liquid, and an attachment unit that attaches the waste liquid container, wherein the attachment unit includes an introduction portion that is insertable into the waste liquid container along a first axis and introduces the liquid into the waste liquid container, and a holding portion that holds the introduction portion, and the introduction portion is held by the holding portion movably along a first plane orthogonal to the first axis.

### BRIEF DESCRIPTION OF THE DRAWINGS

FIG. 1 is a plan view illustrating a schematic configuration of a liquid ejection apparatus according to an embodiment.

FIG. 2 is a perspective view illustrating a configuration of a waste liquid container according to the embodiment.

FIG. 3 is a perspective view illustrating a configuration of an absorber housed in the waste liquid container according to the embodiment.

FIG. 4 is a perspective view illustrating a configuration of an attachment unit to which the waste liquid container according to the embodiment is attached.

FIG. 5 is a perspective view illustrating a configuration of an introduction portion according to the embodiment.

FIG. 6 is a perspective view illustrating a configuration of a holding portion according to the embodiment.

FIG. 7 is a perspective view illustrating the introduction portion held by the holding portion according to the embodiment.

FIG. 8 is a perspective view illustrating the waste liquid container attached to the attachment unit according to the embodiment.

FIG. 9 is a cross-sectional view cut along line S9-S9 shown in FIG. 1.

FIG. 10 is a partial cross-sectional view illustrating a part around the introduction portion inserted into a hole portion of the waste liquid container at an attached position.

FIG. 11 is a partial perspective view illustrating a part around the introduction portion inserted into the hole portion of the waste liquid container at the attached position.

### DESCRIPTION OF EMBODIMENTS

Hereinafter, the present disclosure will be described based on embodiments. In the drawings, the same members have the same signs and the overlapping description will be omitted. The terms “same”, “identical”, and “simultaneous” used in the present specification are not limited to being completely the same.

For example, in the present specification, when the terms “same”, “identical”, and “simultaneous” are used, the meanings thereof include cases where things are the same in consideration of a measurement error. Also, for example, in the present specification, when the terms “same”, “identical”, and “simultaneous” are used, the meanings thereof include cases where things are the same in consideration of a manufacturing variation of the members.

In the present specification, when the terms “same”, “identical”, and “simultaneous” are used, the meanings thereof include cases where things are the same without impairing functions. Therefore, for example, “the dimensions of two members are the same” means that a dimensional difference between the two members is within ±5% of the dimension of one member, particularly preferably within ±3%, in consideration of a measurement error and a manufacturing variation of the members.

In the drawings, X, Y, and Z represent three spatial axes orthogonal to one another. In the present specification, directions along these axes are referred to as X-axis directions, Y-axis directions, and Z-axis directions. When the directions are specified, with “+” for a positive direction and “−” for a negative direction, the positive and negative signs are used in combination with the directions. In the drawings, the directions pointed by arrows are + directions and the opposite directions to the directions pointed by the arrows are-directions.

The Z-axis directions represent the directions of gravity, the +Z direction represents a vertically upward direction, and the −Z direction represents a vertically downward direction. A plane including the X axis and the Y axis is described as an X-Y plane, a plane including the X axis and the Z axis is described as an X-Z plane, and a plane including the Y axis and the Z axis is described as a Y-Z plane. The X-Y plane is a horizontal plane. The three spatial axes X, Y, and Z, which neither limit the positive direction nor limit the negative direction, will be described as the X axis, the Y axis, and the Z axis.

The X-axis directions are horizontal directions along an installation surface, which is a horizontal surface on which a liquid ejection apparatus 1 is installed. The X-axis directions are width directions of a paper P conveyed in the liquid ejection apparatus 1. The Y-axis directions are horizontal directions along the installation surface on which the liquid ejection apparatus 1 is installed. The Y-axis directions are conveyance directions of the paper P conveyed in the liquid ejection apparatus 1.

The Z-axis directions are normal directions with respect to the installation surface on which the liquid ejection apparatus 1 is installed, and height directions of the liquid ejection apparatus 1. In the description below, the +Z direction may be referred to as “vertically above” and the −Z direction may be referred to as “vertically below”. For the sake of convenience of illustration, the size of each member may be different from the actual size.

### Embodiments

A schematic configuration of the liquid ejection apparatus 1 according to the embodiment will be described. In the present embodiment, the liquid ejection apparatus 1 is configured as an inkjet printer, and ejects ink onto the paper P to form an image.

The paper P is an example of a medium, and the ink is an example of a liquid. For the liquid ejection apparatus 1, any type of medium such as a resin film or fabric may be used as an object to which the ink is ejected instead of the paper P.

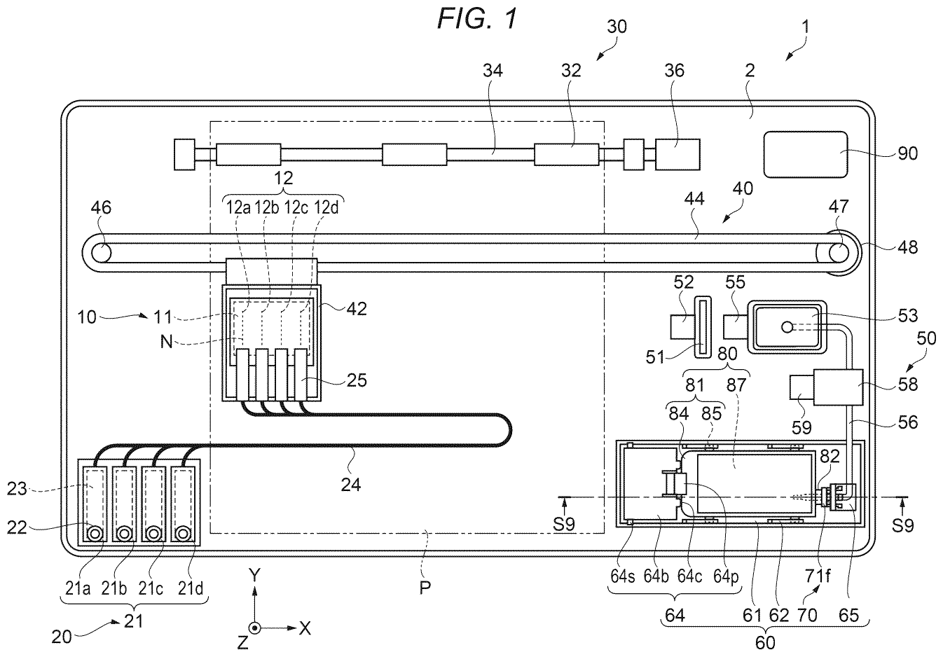

The liquid ejection apparatus 1 includes an apparatus main body 2 illustrated in FIG. 1 and a reading unit (not illustrated). The apparatus main body 2 ejects ink onto the paper P to form an image. The reading unit reads an image of a document to be placed.

The reading unit is attached to the apparatus main body 2 so as to be movable between a closed position where the reading unit covers an opening of the apparatus body 2 that opens toward the +Z direction and an open position where the reading unit opens the opening of the apparatus main body 2. By moving the reading unit to the open position, for example, the user can access an attachment unit 60 of a maintenance section 50 described later from the +Z direction side.

As illustrated in FIG. 1, the liquid ejection apparatus 1 includes an ejection unit 10, a liquid supply unit 20, a conveyance mechanism 30, a movement mechanism 40, the maintenance section 50, and a control unit 90 in the apparatus main body 2.

The ejection unit 10 has a nozzle surface 11 provided with a plurality of nozzle rows 12 for ejecting inks. The nozzle row 12 is formed by arranging a plurality of nozzles N in the Y-axis directions. The ejection unit 10 forms an image on the paper P by ejecting the ink in the −Z direction from the plurality of nozzles N forming the nozzle row 12. In the present embodiment, the plurality of nozzle rows 12 include nozzle rows 12a, 12b, 12c, and 12d.

The inks ejected by the ejection unit 10 are, for example, inks of four colors in total of black, cyan, magenta, and yellow. The ejection unit 10 ejects the respective inks from the nozzle rows 12a, 12b, 12c, and 12d. The ejection unit 10 may eject an ink of any color such as light cyan, light magenta, or white not limited to the four colors described above.

The ejection unit 10 is mounted on a carriage 42 described later provided in the movement mechanism 40, and reciprocates in main scanning directions along with the movement of the carriage 42. In the present embodiment, the main scanning directions are the +X direction and the −X direction.

The liquid supply unit 20 supplies the inks to the ejection unit 10. The liquid supply unit 20 includes a liquid supply source 21, a supply channel 24, and a pressure adjustment mechanism 25.

The liquid supply source 21 of the present embodiment includes an injection portion 22 into which the ink can be injected, and a housing chamber 23 that houses the ink injected from the injection portion 22. The liquid supply source 21 of the present embodiment is a replenishable tank, but may be a replaceable cartridge-type tank.

The liquid supply unit 20 includes a plurality of the liquid supply sources 21. In the present embodiment, the plurality of liquid supply sources 21 include liquid supply sources 21a, 21b, 21c, and 21d. The liquid supply sources 21a, 21b, 21c, and 21d contain the black ink, the cyan ink, the magenta ink, and the yellow ink, respectively.

The ink contained in the liquid supply source 21 is supplied to the ejection unit 10 via the supply channel 24 and the pressure adjustment mechanism 25 to which the supply channel 24 is coupled. A plurality of the supply channels 24 and a plurality of the pressure adjustment mechanisms 25 are provided so that the inks contained in the liquid supply sources 21a, 21b, 21c, and 21d can be supplied to the nozzle rows 12a, 12b, 12c, and 12d, respectively.

The pressure adjustment mechanism 25 couples the supply channel 24 and the ejection unit 10. The pressure adjustment mechanism 25 adjusts the pressure of the ink supplied to the ejection unit 10 at predetermined negative pressure. The pressure adjustment mechanism 25 of the present embodiment is provided in the carriage 42. Therefore, the supply channel 24 of the present embodiment is formed of, for example, a flexible tube.

The conveyance mechanism 30 conveys the paper P in the sub-scanning directions. The sub-scanning directions are directions orthogonal to the X-axis directions as the main scanning directions, and the +Y direction and the −Y direction in the present embodiment. The conveyance mechanism 30 includes a conveyance rod 34 having three conveyance rollers 32, and a conveyance mechanism drive unit 36 that rotationally drives the conveyance rod 34.

When the conveyance mechanism drive unit 36 is driven, the conveyance rod 34 and the plurality of conveyance rollers 32 rotate, and the paper P is conveyed in the −Y direction. Any number of conveyance rollers 32 may be used, not limited to three. The liquid ejection apparatus 1 may include a plurality of conveyance mechanisms 30.

The movement mechanism 40 includes a conveyance belt 44, a pulley 46, a pulley 47, and a movement mechanism drive unit 48 in addition to the carriage 42 described above. The ejection unit 10 and the pressure adjustment mechanisms 25 are mounted on the carriage 42 in a state where the inks can be ejected. The carriage 42 is attached to the conveyance belt 44.

The conveyance belt 44 is looped over the pulley 46 and the pulley 47. When the movement mechanism drive unit 48 is driven, the pulley 47 rotates. By controlling the movement mechanism drive unit 48, the pulley 47 rotates, and the conveyance belt 44 reciprocates in the main scanning directions. Accordingly, the carriage 42 attached to the conveyance belt 44 also reciprocates in the main scanning directions.

The maintenance section 50 performs maintenance of the ejection unit 10. The maintenance section 50 includes a wiper 51, a wiper drive unit 52, a cap 53, a cap drive unit 55, a waste liquid tube 56, a pump 58, a pump drive unit 59, the attachment unit 60, and a waste liquid container 80.

The wiper 51 performs maintenance of the ejection unit 10 by wiping the nozzle surface 11 of the ejection unit 10. When the wiper drive unit 52 is driven, the wiper 51 moves in the Z-axis directions between a standby position where the wiper is not in contact with the nozzle surface 11 and a wiping position where the wiper can come into contact with the nozzle surface 11.

With the wiper 51 at the wiping position, the discharge section 10 moves in the X-axis directions vertically above the wiper 51 along with the movement of the carriage 42, thereby the nozzle surface 11 is wiped.

The liquid ejection apparatus 1 performs maintenance of the ejection unit 10 by draining the ink from the nozzles N of the ejection unit 10. The cap 53 comes into contact with the nozzle surface 11 of the ejection unit 10 to form a cap space in which the nozzles N are opened.

When the cap driver 55 is driven, the cap 53 moves in the Z-axis directions. The cap 53 moves in the Z-axis directions between a non-capping position where the cap is not in contact with the nozzle surface 11 and a capping position where the cap is in contact with the nozzle surface 11.

In the capping position, the cap 53 forms the cap space in which the nozzles N forming the nozzle rows 12a, 12b, 12c, and 12d are opened.

The cap 53 communicates with an introduction portion 70 provided in the attachment unit 60 via the waste liquid tube 56. The waste liquid tube 56 is provided with the pump 58 that applies negative pressure to the cap space formed by the cap 53.

When the pump drive unit 59 is driven, negative pressure is applied by the pump 58 to the cap space formed by the cap 53. Accordingly, the inks are drained from the nozzles N forming the nozzle rows 12a, 12b, 12c, and 12d of the ejection unit 10 to the cap 53.

When the negative pressure is applied to the cap space for a predetermined period, the cap drive unit 55 is driven, so that the cap 53 moves from the capping position to the non-capping position. Subsequently, the pump drive unit 59 is driven to continue the operation of the pump 58.

Accordingly, the inks drained as the waste liquid to the cap 53 flow through the waste liquid tube 56 toward the introduction portion 70.

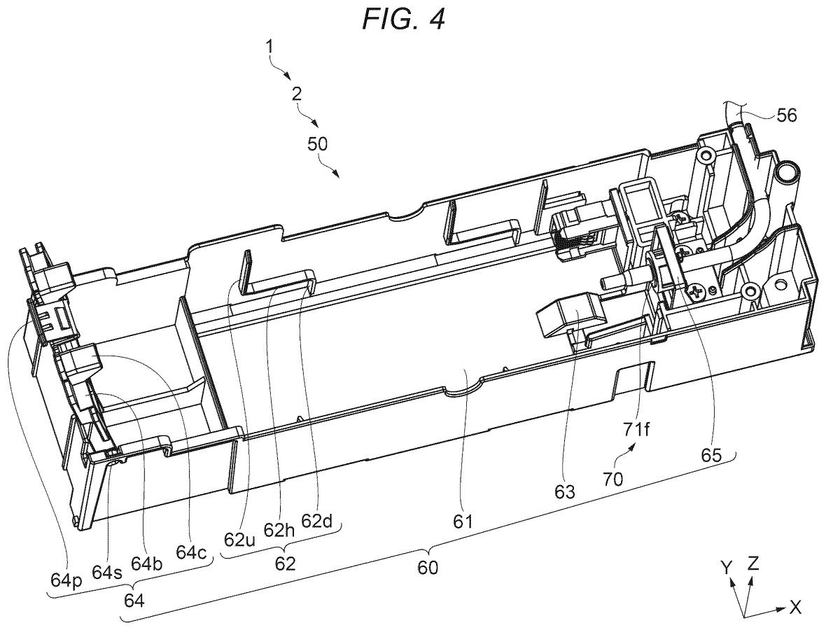

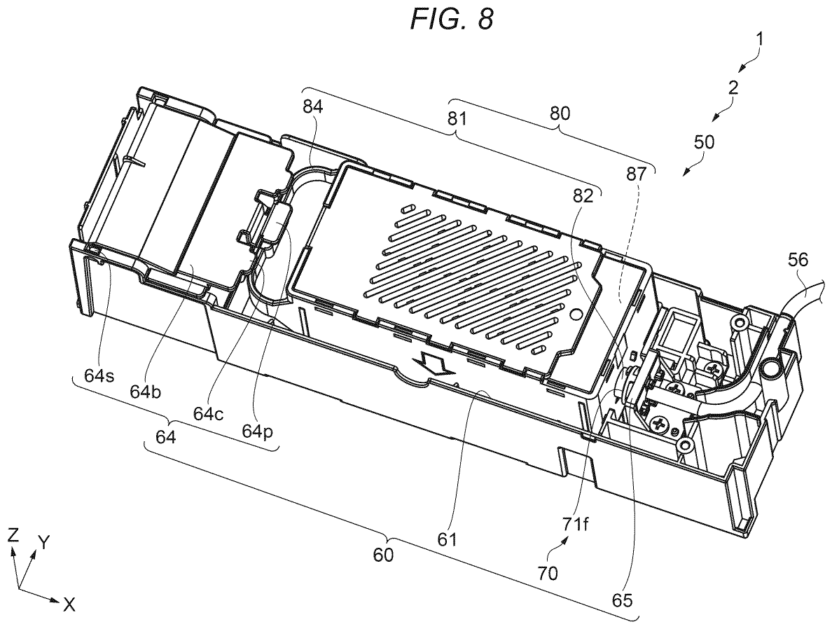

As illustrated in FIGS. 1 and 8, the waste liquid container 80 is detachably attached into a housing portion 61 of the attachment unit 60. As illustrated in FIG. 4, the housing portion 61 opens toward the +Z direction. The waste liquid container 80 is inserted into the housing portion 61 of the attachment unit 60 from the +Z direction side.

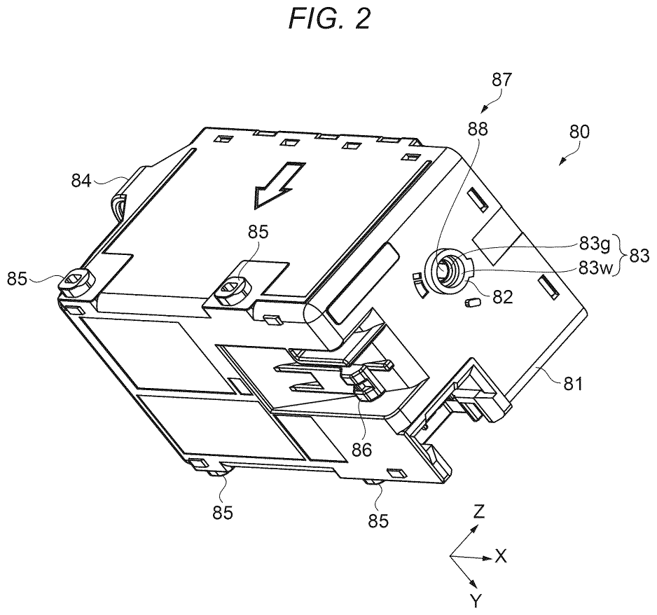

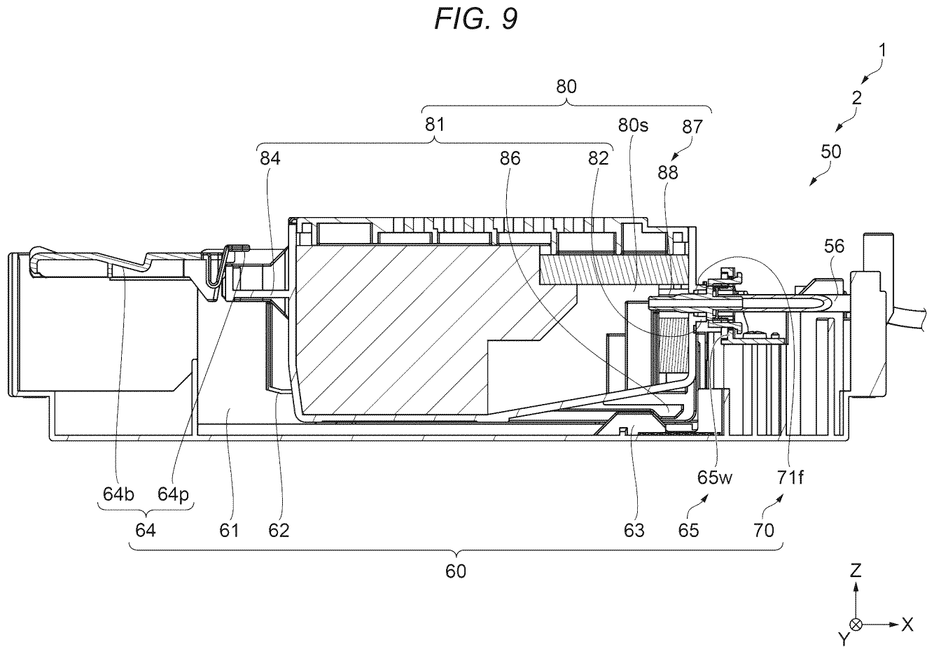

The waste liquid container 80 stores the inks drained as the waste liquid from the ejection unit 10. As illustrated in FIGS. 1 and 9, the waste liquid container 80 includes a case 81 and an absorber 87. The case 81 houses the absorber 87 inside. The case 81 has a rectangular parallelepiped shape. As shown in FIG. 2, the case 81 is provided with a convex portion 82, a grip portion 84, restricted portions 85, and an engagement claw 86.

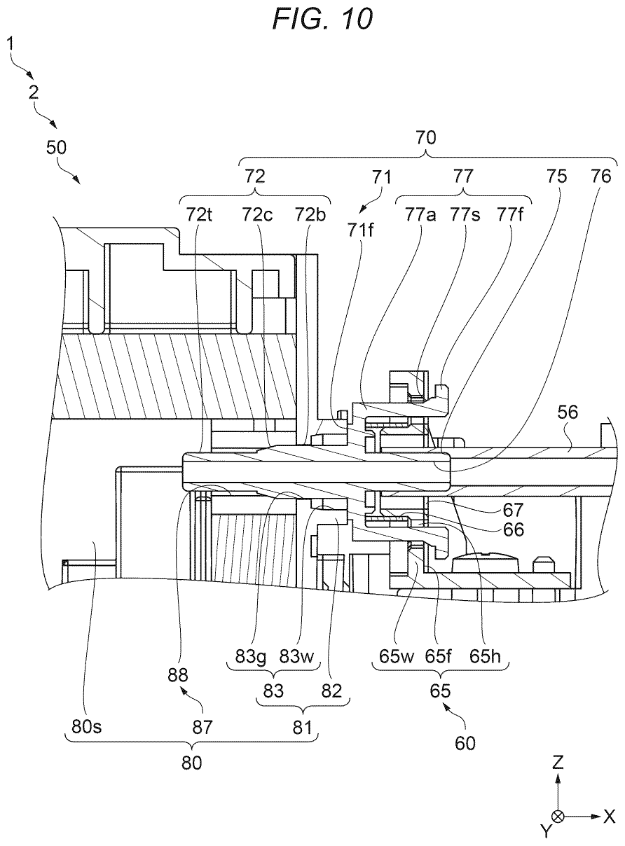

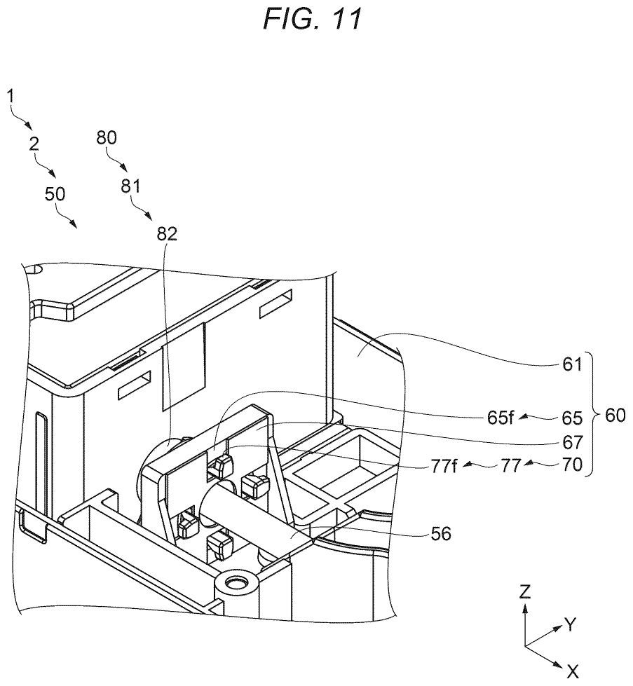

The convex portion 82 is a disk-shaped protrusion protruding from a side wall of the case 81 at the +X direction side. A guide hole 83 into which the introduction portion 70 is inserted is provided at the center of the convex portion 82. As illustrated in FIGS. 2 and 10, the guide hole 83 is a stepped hole penetrating the side wall of the case 81 at the +X direction side and the convex portion 82 along the X-axis directions.

An inner diameter of a guide portion 83g, which is a round hole penetrating a side wall of the case 81 at the +X direction side in the guide hole 83, is smaller than an inner diameter of a guide portion 83w, which is a round hole penetrating the convex portion 82 in the guide hole 83.

As illustrated in FIGS. 1 and 2, the grip portion 84 is a protrusion protruding from a side wall of the case 81 at the −X direction side. By gripping the gripping portion 84, the user can easily attach the waste liquid container 80 to the attachment unit 60.

The restricted portions 85 are protrusions protruding from a side wall at the +Y direction side and a side wall at the −Y direction side of the case 81. Two of the restricted portions 85 are provided on each of the side wall at the +Y direction side and the side wall at the −Y direction side of the case 81 at a distance in the X-axis directions.

As illustrated in FIGS. 2 and 9, the engagement claw 86 is provided on a bottom wall that is a side wall of the case 81 at the −Z direction side.

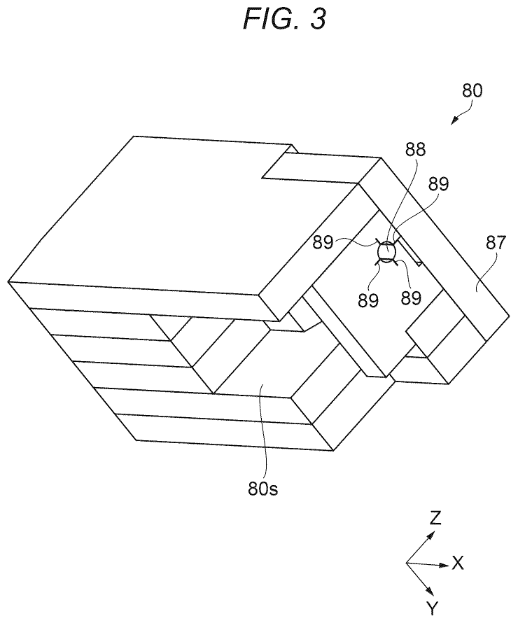

The absorber 87 includes an absorbing member that can hold a liquid by absorbing the liquid. As shown in FIG. 3, the absorber 87 of the present embodiment is formed of a plurality of the absorbing members. The absorbing member has flexibility. As the absorbing member forming the absorber 87, for example, a porous body obtained by forming a resin material such as polyurethane into a sponge form can be adopted.

Alternatively, as the absorbing member forming the absorber 87, a nonwoven fabric formed in a cloth form by binding a resin material such as polypropylene or polyester, a member formed in a plate shape by pressing a paper piece, or the like can be adopted.

As illustrated in FIGS. 9 and 10, the side surface of the absorber 87 at the +X direction side is in contact with an inner surface of the case 81 at the +X direction side. A drain chamber 80s is provided inside the absorber 87. The absorber 87 is provided with a hole portion 88 into which the introduction portion 70 can be inserted.

The hole portion 88 extends in the −X direction from the side surface of the absorber 87 at the +X direction side continuously from the guide hole 83 of the case 81. The hole portion 88 is a round hole penetrating a part between the side surface of the absorber 87 at the +X direction side and the drain chamber 80s. A center axis (not illustrated) of the hole portion 88 is along the X axis. The inner diameter of the hole portion 88 is set to be smaller than the inner diameter of the guide portion 83g in the guide hole 83 of the case 81.

Further, as illustrated in FIG. 3, four cut portions 89 extending in the +Y direction, the −Y direction, the +Z direction, and the −Z direction, which are radial directions, from the circumferential surface of the hole portion 88 are provided in a part between the side surface of the absorber 87 at the +X direction side and the drain chamber 80s. The directions in which the cut portions 89 extend from the circumferential surface of the hole portion 88 may not be along the Y-axis directions and the Z-axis directions. The number of the cut portions 89 may be less than four or more than four.

As illustrated in FIG. 4, the attachment unit 60 includes the housing portion 61 described above, a lock portion 64, and a holding portion 65. The housing portion 61 is provided with a restricting portion 62 and an engagement portion 63.

The restricting portion 62 restricts the movement of the waste liquid container 80 in the +X direction and the +Z direction from an attached position by coming into contact with the restricted portion 85 of the waste liquid container 80. The waste liquid container 80 illustrated in FIGS. 1 and 8 to 11 is at the attached position.

The restricting portion 62 is a protrusion protruding from an inner surface at the +Y direction side and an inner surface at the −Y direction side of the housing portion 61. Two of the restricting portions 62 are provided on each of the inner surface at the +Y direction side and the inner surface at the −Y direction side of the housing portion 61 at a distance in the X-axis directions.

The restricting portion 62 includes a protruding portion 62u extending in the Z-axis directions, a protruding portion 62h extending in the +X direction continuously from an end of the protruding portion 62u in the −Z direction, and a protruding portion 62d extending in the −Z direction continuously from an end of the protruding portion 62h in the +X direction.

When the waste liquid container 80 is inserted into the attachment unit 60 from the +Z direction side toward the −Z direction, each protruding portion 62u comes into contact with the +X direction side of the corresponding restricted portion 85 to guide the insertion of the waste liquid container 80 into the housing portion 61.

When the waste liquid container 80 is inserted into contact with an inner bottom surface as the inner surface of the housing portion 61 at the −Z direction side and then moved in the +X direction toward the attached position, each protruding portion 62h comes into contact with the +Z direction side of the corresponding restricted portion 85.

Accordingly, each protruding portion 62h guides the movement of the waste liquid container 80 in the +X direction toward the attached position together with the inner bottom surface of the housing portion 61. Further, each protruding portion 62h comes into contact with the +Z direction side of the restricted portion 85, thereby restricting the movement of the waste liquid container 80 at the attached position in the +Z direction.

Each protruding portion 62d comes into contact with the +X direction side of the corresponding restricted portion 85, thereby restricting the movement of the waste liquid container 80 at the attached position in the +X direction.

The engagement portion 63 engages with the engagement claw 86 of the waste liquid container 80, thereby restricting the movement of the waste liquid container 80 at the attached position in the −X direction. The engagement portion 63 is a protrusion protruding in the +Z direction from the inner bottom surface of the housing portion 61. The engagement between the engagement portion 63 and the engagement claw 86 can be released by the user moving the waste liquid container 80 in the −X direction.

As illustrated in FIGS. 1 and 8, the lock portion 64 comes into contact with the grip portion 84 of the waste liquid container 80, thereby restricting the movement of the waste liquid container 80 at the attached position in the −X direction. The lock portion 64 includes a main body 64b, a rotation shaft 64s, a lug portion 64p, and a contact portion 64c.

The rotation shaft 64s is a cylindrical protrusion protruding from the main body 64b in the +Y direction and the −Y direction. The rotation shaft 64s is supported by the attachment unit 60 in a direction in which the center axis (not illustrated) of the rotation shaft 64s extends along the Y-axis directions. The rotation shaft 64s is rotatably supported by the attachment unit 60, and thus the lock portion 64 pivots between an open position (see FIG. 4) and a closed position (see FIGS. 1, 8, and 9).

The lug portion 64p is provided at the +X direction side of the main body 64b when the lock portion 64 is at the closed position. As shown in FIG. 9, the lug portion 64p and the main body 64b are coupled by a hinge. The hinge is deformed, thereby changing the position of the lug portion 64p with respect to the main body 64b.

When the lock portion 64 is at the open position, the waste liquid container 80 can be inserted into the attachment unit 60. The lug portion 64p is displaced in contact with the grip portion 84 of the waste liquid container 80 in the process of pivoting the lock portion 64 from the open position to the closed position.

Thus, the lug portion 64p engages with the grip portion 84 when the lock 64 is in the closed position. The lug portion 64p engages with the grip portion 84, thereby restricting the pivot of the lock portion 64 at the closed position around the rotation shaft 64s.

When the lock portion 64 is moved from the closed position to the open position, the user holds and displaces the lug portion 64p, thereby moving the lock portion 64 to the open position while releasing the engagement between the lug portion 64p and the grip portion 84.

As illustrated in FIGS. 1 and 8, the contact portion 64c is a protrusion protruding in the +X direction from the main body 64b when the lock portion 64 is at the closed position. The contact portion 64c is provided at the +Y direction side and the −Y direction side of the lug portion 64p in the Y-axis directions.

When the lock portion 64 is at the closed position, the contact portion 64c contacts an end of the grip portion 84 at the −X direction side. Accordingly, at the closed position, the lock portion 64 restricts the movement of the waste liquid container 80 at the attached position in the −X direction.

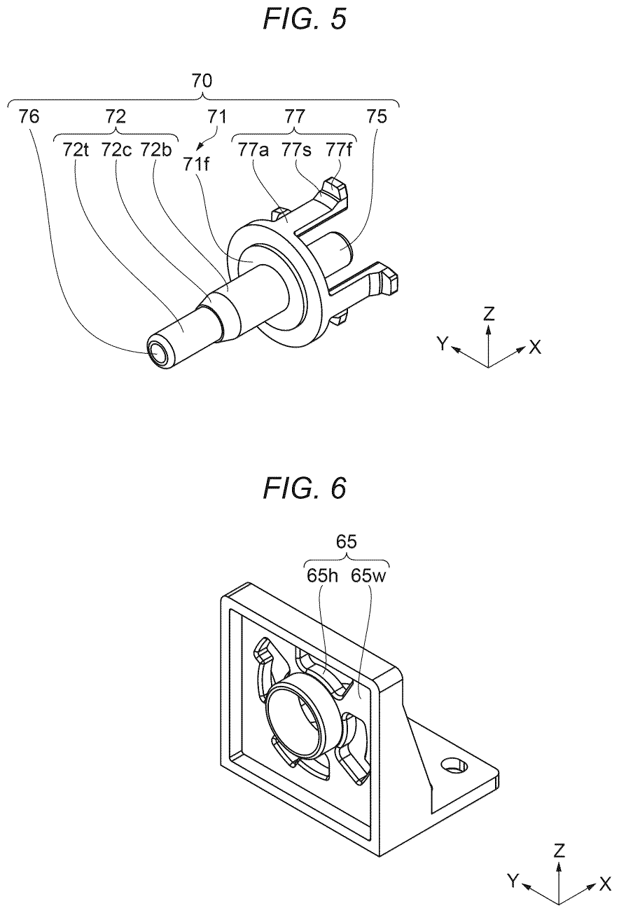

The holding portion 65 that holds the introduction portion 70 is provided at the +X direction side of the housing portion 61. Accordingly, the introduction portion 70 is provided at the +X direction side of the housing portion 61. As illustrated in FIG. 5, the introduction portion 70 includes a flange portion 71, an insertion portion 72, a joint portion 75, an introduction hole 76, and an engagement claw 77.

The flange portion 71 has a disk shape. The insertion portion 72 is provided at the center of an abutment surface 71f, which is a surface of the flange portion 71 at the −X direction side. The joint portion 75 is provided at the center of a surface of the flange portion 71 at the +X direction side.

The insertion portion 72 extends from the abutment surface 71f of the flange portion 71 in the −X direction along the center axis (not illustrated) of the flange portion 71. The insertion portion 72 includes a coupling portion 72b, a tapered portion 72c, and an end portion 72t.

The coupling portion 72b has a cylindrical shape extending in the −X direction from the abutment surface 71f. The end portion 72t forms an end of the insertion portion 72 in the −X direction, and has a cylindrical shape. The diameter of the outer circumferential surface of the end portion 72t is smaller than the diameter of the outer circumferential surface of the coupling portion 72b. The tapered portion 72c couples between the coupling portion 72b and the end portion 72t.

When the waste liquid container 80 inserted into the attachment unit 60 is moved in the +X direction toward the attached position, as illustrated in FIG. 10, the insertion portion 72 is inserted into the hole portion 88 of the absorber 87 through the guide hole 83 of the waste liquid container 80.

The insertion dimension in the X-axis directions when the insertion portion 72 is inserted into the hole portion 88 of the absorber 87 in the waste liquid container 80 at the attached position is defined by the abutment surface 71f of the flange portion 71 coming into contact with the convex portion 82.

Accordingly, the end portion 72t, the tapered portion 72c, and the coupling portion 72b of the insertion portion 72 are positioned inside the hole portion 88 of the absorber 87 in the waste liquid container 80 at the attached position.

The outer diameter of the end portion 72t of the insertion portion 72 is smaller than the inner diameter of the guide portion 83g of the guide hole 83 and the inner diameter of the hole portion 88 of the absorber 87. The outer diameter of the coupling portion 72b of the insertion portion 72 is equal to or smaller than the inner diameter of the guide portion 83g of the guide hole 83 and larger than the inner diameter of the hole portion 88 of the absorber 87.

Accordingly, due to the contact between the inner circumferential surface of the hole portion 88 of the absorber 87 and the outer circumferential surface of the coupling portion 72b of the insertion portion 72, the waste liquid container 80 at the attached position and the introduction portion 70 are coupled to prevent leakage of the waste liquid.

The joint portion 75 has a cylindrical shape extending in the +X direction along the center axis of the flange portion 71 from the surface of the flange portion 71 at the +X direction side. The introduction hole 76 is a hole penetrating the introduction portion 70 from the end of the joint portion 75 in the +X direction to the tip of the insertion portion 72.

When the waste liquid tube 56 is coupled to the joint portion 75, the introduction portion 70 can drain the waste liquid from the tip of the insertion portion 72 to the drain chamber 80s of the waste liquid container 80 at the attached position via the introduction hole 76.

As illustrated in FIG. 5, four of the engagement claws 77 are provided to extend in the +X direction from the end in the +Y direction, the end in the −Y direction, the end in the +Z direction, and the end in the −Z direction of the flange portion 71. Each engagement claw 77 includes an arm portion 77a, an inclined surface 77s, and a claw portion 77f.

The arm portion 77a has a plate shape extending in the +X direction from the flange portion 71. The claw portion 77f is a protrusion that is provided at an end as an end of the arm portion 77a in the +X direction and protrudes from the arm portion 77a in the radial direction of the flange portion 71. The inclined surface 77s is provided between the end of the arm portion 77a and the surface of the claw portion 77f at the −X direction side.

As illustrated in FIG. 6, the holding portion 65 includes a standing wall 65w and an attachment hole 65h provided in the standing wall 65w. The standing wall 65w has a plate shape extending in the +Z direction from the bottom surface of the attachment unit 60. As illustrated in FIGS. 10 and 11, an engagement surface 65f that engages with the claw portion 77f of the engagement claw 77 of the introduction portion 70 is provided on a side surface of the standing wall 65w at the +X direction side.

As shown in FIGS. 6 and 10, the attachment hole 65h is a hole penetrating the standing wall 65w in the X-axis directions. Four of the attachment holes 65h are provided in the standing wall 65w so that the four engagement claws 77 of the introduction portion 70 can be inserted thereinto when the introduction portion 70 is attached to the holding portion 65.

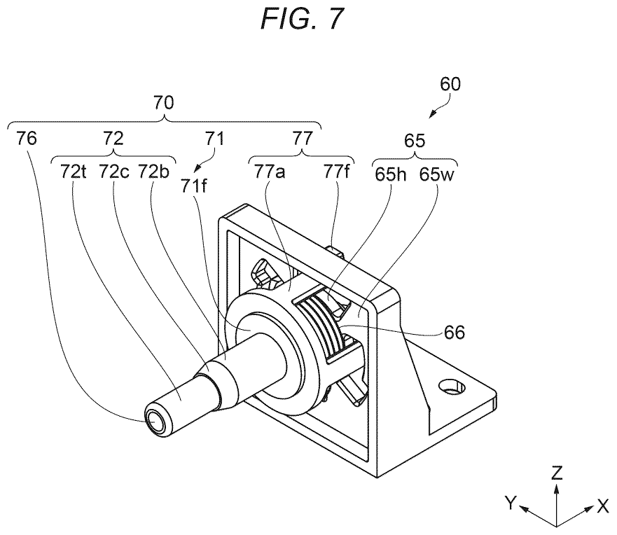

When the introduction portion 70 is attached to the holding portion 65, as illustrated in FIG. 7, the engagement claw 77 of the introduction portion 70 is inserted into the attachment hole 65h from the −X direction side of the standing wall 65w with a compression coil spring 66 sandwiched between the introduction portion 70 and the holding portion 65.

Then, with the engagement claw 77 inserted into the attachment hole 65h, the introduction portion 70 is rotated around the center axis of the flange portion 71, so that the claw portion 77f of the engagement claw 77 and the engagement surface 65f are engaged with each other.

Accordingly, as illustrated in FIG. 10, the introduction portion 70 is biased toward the −X direction by the compression coil spring 66 disposed between the flange portion 71 and the standing wall 65w.

Accordingly, when the waste liquid container 80 is at the attached position, the introduction portion 70 is biased by the compression coil spring 66 in a direction in which the abutment surface 71f is closer to the convex portion 82 of the waste liquid container 80. The compression coil spring 66 is an example of a biasing portion that biases the introduction portion 70 toward the waste liquid container 80 along the X axis. The X axis is an example of a first axis.

As shown in FIG. 4, when the waste liquid container 80 is not housed in the housing portion 61 of the attachment unit 60, the introduction portion 70 is positioned at a neutral position. At the neutral position, the introduction portion 70 is biased in the −X direction by the compression coil spring 66, so that the surface of the claw portion 77f of the engagement claw 77 at the −X direction side and the engagement surface 65f are in contact with each other.

The force with which the introduction portion 70 is biased toward the −X direction by the compression coil spring 66 is set to be larger than the force necessary for insertion of the coupling portion 72b of the insertion portion 72 in the introduction portion 70 into the hole portion 88 of the absorber 87.

The force with which the introduction portion 70 is biased toward the −X direction by the compression coil spring 66 is smaller than the force necessary for release of the engagement between the engagement portion 63 of the attachment unit 60 and the engagement claw 86 of the waste liquid container 80.

Then, a retaining member 67 (see FIGS. 10 and 11) is attached to the +X direction side of the standing wall 65w. As a result, the introduction portion 70 rotates in the direction opposite to the rotation direction when the claw portion 77f of the engagement claw 77 and the engagement surface 65f are engaged with each other, so that the claw portion 77f is prevented from coming out of the attachment hole 65h of the holding portion 65.

As described above, the introduction portion 70 is attached to the holding portion 65 and held by the holding portion 65 in a state in which the introduction portion 70 can be inserted into the waste liquid container 80 along the X axis. As described above, the introduction portion 70 is attached to the holding portion 65 and held by the holding portion 65 in a state in which the introduction portion 70 is movable along the Y-Z plane. The Y-Z plane is an example of a first plane orthogonal to the X axis as the example of the first axis. In the direction along the Y-Z plane, the neutral position of the introduction portion 70 is located at the center of the range in which the introduction portion 70 is movable with respect to the holding portion 65.

In the process in which the waste liquid container 80 inserted into the attachment unit 60 is moved in the +X direction toward the attached position by the user, the insertion portion 72 in the introduction portion 70 is inserted into the guide portion 83g and the hole portion 88 of the waste liquid container 80. The coupling portion 72b is inserted into the guide portion 83g and the hole portion 88 continuously from the end portion 72t and the tapered portion 72c of the insertion portion 72.

In the process in which the end portion 72t and the tapered portion 72c of the insertion portion 72 are inserted into the guide portion 83g, when the outer circumferential surface of the insertion portion 72 comes into contact with the inner circumferential surface of the guide portion 83g due to misalignment between the insertion portion 72 and the guide portion 83g, an external force acts on the introduction portion 70. The introduction portion 70 moves in the direction along the Y-Z plane from the neutral position by the action of the external force.

Accordingly, the introduction portion 70 is aligned with respect to the guide portion 83g. Subsequently, the waste liquid container 80 is moved in the +X direction toward the attached position, and thus the coupling portion 72b of the introduction portion 70 is inserted into the hole portion 88 with the introduction portion 70 aligned with respect to the guide portion 83g.

Subsequently, the waste liquid container 80 is moved in the +X direction toward the attached position, and thus the abutment surface 71f of the introduction portion 70 comes into contact with the convex portion 82 of the waste liquid container 80. Accordingly, the coupling between the hole portion 88 of the waste liquid container 80 and the insertion portion 72 of the introduction portion 70 is completed.

After the coupling between the hole portion 88 of the waste liquid container 80 and the insertion portion 72 of the introduction portion 70 is completed, the waste liquid container 80 and the introduction portion 70 are moved in the +X direction and reach the attached position by being moved (see FIGS. 10 and 11).

The movement of the waste liquid container 80 reaching the attached position from the attached position is restricted by the engagement between the engaging portion 63 of the attachment unit 60 and the engaging claw 86 and the contact between the restricting portion 62 of the attachment unit 60 and the restricted portion 85.

When the user moves the lock portion 64 to the closed position with the waste liquid container 80 at the attached position, the attachment of the waste liquid container 80 to the attachment unit 60 is completed (see FIG. 8). As illustrated in FIGS. 9 to 11, when the waste liquid container 80 is at the attached position, the introduction portion 70 is positioned in the +X direction with respect to the neutral position in the X axis directions.

The user detaches the waste liquid container 80 from the attachment unit 60, and thus the introduction portion 70 moves in the −X direction from the position when the waste liquid container 80 is at the attached position by the biasing force of the compression coil spring 66.

For example, it is assumed that the introduction portion 70 is moved in the direction along the Y-Z plane from the neutral position by alignment with the guide portion 83g. In this case, in the movement process of the introduction portion 70 in the −X direction, one of the inclined surfaces 77s of the engagement claw 77 comes into contact with the edge of the attachment hole 65h of the holding portion 65.

As a result, an external force acts on the one of the inclined surfaces 77s. Due to the action of the external force on the inclined surface 77s, in the movement process of the introduction portion 70 in the −X direction, the introduction portion 70 moves in the direction along the Y-Z plane and returns to the neutral position from the position aligned with the guide portion 83g.

Although not illustrated, the control unit 90 includes a CPU (Center Processing Unit). The control unit 90 has a storage unit including a RAM (Random Access Memory) and a ROM (Read Only Memory). The storage unit stores various programs for controlling the liquid ejection apparatus 1.

The control unit 90 may include one or more processors that execute various kinds of processing according to the programs, one or more dedicated hardware circuits such as an ASIC (Application Specific Integrated Circuit), or a combination thereof. The application specific integrated circuit ASIC executes at least part of various kinds of processing.

The processor includes a CPU and a memory such as a RAM and a ROM. The memory stores program codes or commands configured for the CPU to execute processing. The memory, that is, a computer-readable medium includes any medium that can be accessed by a general-purpose or dedicated computer.

The control unit 90 in FIG. 1 is conceptually illustrated, and is actually configured using a circuit board provided at a predetermined position of the liquid ejection apparatus 1. The control unit 90 is electrically coupled to the respective units provided in the liquid ejection apparatus 1 to perform integrated control of the operations of the respective units.

For example, the control unit 90 controls the conveyance mechanism drive unit 36 of the conveyance mechanism 30 to convey the paper P toward the ejection unit 10. The control unit 90 controls the movement mechanism drive unit 48 of the movement mechanism 40 and the ejection unit 10 to eject the inks onto the paper P while moving the carriage 42 and the ejection unit 10 in the X-axis directions, thereby forming an image.

For example, the control unit 90 controls the wiper drive unit 52 of the maintenance section 50 and the movement mechanism drive unit 48 of the movement mechanism 40 to wipe the nozzle surface 11 with the wiper 51. As a result, the maintenance of the ejection unit 10 by wiping the nozzle surface 11 is performed.

For example, the control unit 90 controls the movement mechanism drive unit 48 of the movement mechanism 40 and the cap drive unit 55 of the maintenance section 50 to form the cap space by the cap 53.

The control unit 90 drives the pump drive unit 59 to apply negative pressure by the pump 58 to the cap space formed by the cap 53. The inks are drained from the ejection unit 10 into the cap 53 by applying the negative pressure to the cap space.

The inks ejected as the waste liquid into the cap 53 is absorbed and held by the absorber 87 of the waste liquid container 80 via the waste liquid tube 56 and the introduction hole 76 of the introduction portion 70. As a result, the maintenance of the ejection unit 10 by ejecting the ink is performed.

As described above, according to the liquid ejection apparatus 1 according to the embodiment, the following effects can be obtained.

The liquid ejection apparatus 1 includes the ejecting unit 10 that ejects the inks, the waste liquid container 80 that contains the ink as the waste liquid, and the attachment unit 60 for attachment of the waste liquid container 80. The attachment unit 60 has the introduction portion 70 that can be inserted into the waste liquid container 80 along the X axis and introduces the ink into the waste liquid container 80. The attachment unit 60 has the holding portion 65 that holds the introduction portion 70. The introduction portion 70 is held by the holding portion 65 movably along the Y-Z plane orthogonal to the X axis.

According to the configuration, since the position of the introduction portion 70 with respect to the waste liquid container 80 attached into the attachment unit 60 can be adjusted in the directions along the Y-Z plane, the liquid leakage in the coupling portion between the introduction portion 70 and the waste liquid container 80 can be suppressed.

The holding portion 65 is provided with the compression coil spring 66 that biases the introduction portion 70 toward the waste liquid container 80 along the X axis, and the introduction portion 70 is held by the holding portion 65 in movably along the X axis.

According to the configuration, since the position of the introduction portion 70 with respect to the waste liquid container 80 attached into the attachment unit 60 can be adjusted in the directions along the X axis, liquid leakage in the coupling portion between the introduction portion 70 and the waste liquid container 80 can be suppressed.

The waste liquid container 80 includes the absorber 87 that absorbs the waste liquid, and the absorber 87 is provided with the hole portion 88 into which the introduction portion 70 can be inserted and the cut portions 89 provided in the circumferential surface of the hole portion 88. According to the configuration, the insertion load when the introduction portion 70 is inserted into the hole portion 88 can be reduced.

The diameter of the hole portion 88 is smaller than the maximum diameter of the portion of the introduction portion 70 located in the hole portion 88 when the waste liquid container 80 is attached into the attachment unit 60. According to the configuration, liquid leakage in the coupling portion between the introduction portion 70 and the waste liquid container 80 can be suppressed, and the waste liquid adhering to the introduction portion 70 can be wiped off by the hole portion 88.

The introduction portion 70 has the abutment surface 71f that comes into contact with the convex portion 82 of the waste liquid container 80 in the insertion process into the waste liquid container 80. According to the configuration, since the insertion dimension of the introduction portion 70 into the waste liquid container 80 is defined by the abutment surface 71f coming into contact with the convex portion 82, liquid leakage in the coupling portion between the introduction portion 70 and the waste liquid container 80 can be suppressed.

The introduction portion 70 has the plurality of engagement claws 77. The holding portion 65 has the plurality of attachment holes 65h provided so that the respective engagement claws 77 can be inserted. The introduction portion 70 with the engagement claws 77 inserted into the attachment holes 65h rotates around the rotation axis along the X axis, and thus the introduction portion 70 is held by the holding portion 65. According to the configuration, the introduction portion 70 can be easily held by the holding portion 65.

The liquid ejection apparatus 1 according to the embodiment described above of the present disclosure basically has the configurations as described above, but obviously, modifications, omissions, and the like of partial configurations without departing from the gist of the present disclosure can be made. The embodiment described above and other embodiments described below can be combined with each other as long as no technical inconsistencies are involved. The other embodiments will now be described.

In the embodiment described above, the guide hole 83 of the waste liquid container 80 may not be the stepped hole. For example, the guide hole 83 may have the same inner diameter from the end of the convex portion 82 to the inner surface of the side wall on which the convex portion 82 is provided in the case 81. In this case, the inner diameter of the guide hole 83 may be the same as the inner diameter of the guide part 83g.

Alternatively, the guide hole 83 may have a funnel shape in which the inner diameter decreases from the end of the convex portion 82 to the inner surface of the side wall on which the convex portion 82 is provided in the case 81. In this case, the inner diameter of the guide hole 83 on the inner surface of the side wall of the case 81 on which the protrusion 82 is provided may be the same as the inner diameter of the guide portion 83g.

In the embodiment described above, as long as the insertion portion 72 can be inserted into the guide portion 83g of the waste liquid container 80, the introduction portion 70 may not be located at the neutral position when the waste liquid container 80 is not in the attachment unit 60. For example, when the waste liquid container 80 is not in the attachment unit 60, the introduction portion 70 may be located at a position deviated from the neutral position in the direction along the Y-Z plane.

In this case, in the process in which the waste liquid container 80 is moved toward the attached position, the introduction portion 70 is aligned with respect to the guide portion 83g by moving in the direction along the Y-Z plane from the position deviated from the neutral position. In the embodiment, the introduction portion 70 may not include the inclined surface 77s in the engagement claw 77.

In the embodiment described above, the waste liquid container 80 may not include the engagement claw 86 in the case 81. In this case, the attachment unit 60 may include a hook that engages with a protrusion provided on the case 81 of the waste liquid container 80 in the housing portion 61. In this case, the attachment unit 60 may not include the engagement portion 63 in the housing portion 61.

In the embodiment described above, the attachment unit 60 may not include the lock portion 64.

In the embodiment described above, the absorber 87 may not include the cut portion 89.

In the embodiment described above, the waste liquid container 80 may not include the convex portion 82. In this case, in the insertion process into the waste liquid container 80, the insertion dimension of the introduction portion 70 into the waste liquid container 80 may be defined by the abutment surface 71f coming into contact with the side wall provided with the guide portion 83g in the case 81.

In the embodiment described above, the insertion portion 72 of the introduction portion 70 may not include the coupling portion 72b, the tapered portion 72c, and the end portion 72t. For example, the insertion portion 72 may include the coupling portion 72b and the tapered portion 72c. In this case, the tapered portion 72c forms the end of the insertion portion 72. In this case, the coupling portion 72b may be positioned inside the hole portion 88 of the absorber 87 in the waste liquid container 80 at the attached position.

In the embodiment described above, when the waste liquid container 80 is at the attached position, the introduction portion 70 may not be biased by the compression coil spring 66 in the direction toward the waste liquid container 80. For example, the biasing portion that biases the introduction portion 70 in the direction toward the waste liquid container 80 may be an extension coil spring, a leaf spring, an elastic resin member, a rubber member, or the like attached between the introduction portion 70 and the holding portion 65.

In the embodiment described above, the waste liquid container 80 may not be inserted into the housing portion 61 of the attachment unit 60 from the +Z direction side. For example, the waste liquid container 80 may be inserted into the housing portion 61 of the attachment unit 60 in the +Y direction from the −Y direction side of the apparatus main body 2. In the embodiment, the housing portion 61 opens toward the −Y direction.

In the embodiment, the introduction portion 70 is held by the holding portion 65 in a state in which the introduction portion 70 can be inserted into the waste liquid container 80 along the Y axis. In the embodiment, the introduction portion 70 is held by the holding portion 65 movably along the X-Z plane. In this case, the Y axis is an example of the first axis, and the X-Z plane is an example of the first plane orthogonal to the Y axis as the example of the first axis.

What is claimed is:

1. A liquid ejection apparatus comprising:
an ejection unit that ejects a liquid;
a waste liquid container that contains the liquid as a waste liquid; and
an attachment unit that attaches the waste liquid container, wherein
the attachment unit includes
an introduction portion that is insertable into the waste liquid container along a first axis and introduces the liquid into the waste liquid container, and
a holding portion that holds the introduction portion, and
the introduction portion is held by the holding portion movably along a first plane orthogonal to the first axis.

2. The liquid ejection apparatus according to claim 1, wherein
the holding portion is provided with a biasing portion that biases the introduction portion toward the waste liquid container along the first axis, and
the introduction portion is held by the holding portion movably along the first axis.

3. The liquid ejection apparatus according to claim 1, wherein
the waste liquid container includes an absorber that absorbs the waste liquid, and
the absorber is provided with a hole portion into which the introduction portion is insertable and a cut portion provided in a circumferential surface of the hole portion.

4. The liquid ejection apparatus according to claim 3, wherein
a diameter of the hole portion is smaller than a maximum diameter of a portion of the introduction portion located in the hole portion when the waste liquid container is attached into the attachment unit.

5. The liquid ejection apparatus according to claim 1, wherein
the introduction portion has an abutment surface that comes into contact with a convex portion of the waste liquid container in an insertion process into the waste liquid container.

6. The liquid ejection apparatus according to claim 1, wherein
the introduction portion includes a plurality of engagement claws,
the holding portion includes a plurality of attachment holes into which the respective engagement claws are insertable, and
the introduction portion is held by the holding portion when the introduction portion with the engagement claws inserted into the attachment holes rotates around a rotation axis along the first axis.
